(19) United States
(12) Patent Application Publication
(10) Pub. No.: US 2026/0241632 A1
(43) Pub. Date: Aug. 20, 2026

(54) CORE PANELS FOR A WIND TURBINE BLADE

(71) Applicant: KURVATUR A/S, Haderslev (DK)

(72) Inventor: Christian Raun, Haderslev (DK)

(73) Assignee: KURVATUR A/S, Haderslev (DK)

(21) Appl. No.: 19/157,051

(22) PCT Filed: Feb. 14, 2024
(86) PCT No.: PCT/EP2024/053658

§ 371 Date: Aug. 15, 2025

(30) Foreign Application Priority Data
Feb. 16, 2023 (LU) LU503500

(51) Int. Cl. B29C 51/36; B29C 33/30; B29C 37/00; B29C 51/42; B29L 9/00; B29L 31/08

(52) U.S. Cl. CPC B29C 51/36; B29C 33/308; B29C 51/421; B29C 2037/903; B29L 2009/00; B29L 2031/085

(57) ABSTRACT

A method of forming curved panels for a core of a wind turbine blade. The method includes providing a mould, the mould comprising a sheet and a plurality of actuation devices. The method controls an arrangement of the plurality of actuation devices to curve the sheet and mould heated stock material against the sheet to form a first curved panel. The method controls a rearrangement of the plurality of actuation devices to curve the sheet and moulds heated stock material against the sheet to form a second panel. The first and second panels may be assembled together to form the core of the at least part of the wind turbine blade.

### TECHNICAL FIELD

The present disclosure generally relates to core panels for a wind turbine blade and methods of making the core panels, as well as wind turbine blades and wind turbines made using an assembly of the core panels.

### BACKGROUND

FIG. 1 provides a cross-sectional perspective view of a part of a wind turbine blade 10 according to one exemplary prior art construction. The wind turbine blade includes shell halves that are joined to form a shell 8 of the wind turbine blade 10. The shell 8 is reinforced by a shear web 20 bridging a hollow interior defined by the shell 8 and extending between the shell halves. The shell 8 extends from a route to a tip of the wind turbine blade 10 and changes in curvature in a direction along a longitudinal blade axis and around a periphery of a lateral blade axis. As such, the shell 8 is made up of a complex three-dimensional curved shape that must be accommodated by the materials forming the shell 8.

The shell 8 is made of a sandwich structure including an inner skin 14, an outer skin 12 and a core 16 therebetween. The inner and outer skins 14, 12 are often respectively made of a lay-up of unidirectional glass fiber fabrics so that the fibers of each layer of fabric is angled (e.g. at 45°) relative to adjacent layers with a foam or balsa core 16 disposed therebetween. Balsa and foam cores include scores 18 to create hinges that allow the core to conform to curved surfaces of a mould of the wind turbine blade. The sandwich of inner skin 14, core 16 and outer skin 12 is infused with resin (such as epoxy resin) during manufacturing prior to curing to create the shell. Referring to FIG. 2, the scores 18 of a known core 16 can be seen and these will be filled with resin when manufacturing the shell 8. The scoring creates gaps, or kerfs, in the surface of the core where one segment angles away from another to facilitate conformance to the curved mould. The kerfs may help facilitate resin flow, but also fill with resin.

The resin is a CO₂-heavy substance and adds considerable weight to the wind turbine blade 10. Furthermore, scoring the cores also weakens the cores. Some attempts have been made to reduce the resin requirement for the cores but these attempts have concentrated on reducing the scoring, which does not fully address the problems.

Accordingly, it is desirable to provide wind turbine blades cores, and methods of making wind turbine blades cores, that significantly decrease resin usage, increase core strength and are more CO₂ friendly. It is further desirable to provide methods that can increase efficiency of manufacturing wind turbine blades and their cores. Furthermore, other desirable features and characteristics of the present invention will become apparent from the subsequent detailed description and the appended claims, taken in conjunction with the accompanying drawings and the foregoing technical field and background.

### SUMMARY

In a first aspect, a method of forming curved panels for a core of a wind turbine blade is provided. The method includes providing a mould, the mould comprising a sheet and a plurality of actuation devices. The method further includes controlling an arrangement of the plurality of actuation devices to curve the sheet based on a digital design file including a representation of a curved shape of a first curved panel to be moulded and moulding heated stock material against the sheet to form the first curved panel. The method includes controlling, via the at least one processor, a rearrangement of the plurality of actuation devices to curve the sheet based on the digital design file including a representation of a curved shape of a second curved panel to be moulded and moulding heated stock material against the sheet to form the second panel. The digital design file defines the core of at least part of the wind turbine blade that has been divided into curved panels. The first and second panels may be assembled together to form the core of the at least part of the wind turbine blade.

The method provided allows the core to be produced with the required curvature so that there is no need to subsequently score the core. As such, resin does not impregnate the core and the overall weight can be reduced. Further, there is no need to weaken the core by including scores. A blade design can be divided into many (e.g. hundred(s)) of core panels and assembled together to form the core of the sandwich structure of the shell of a wind turbine blade and each panel can be moulded into its individual curved shape by rearrangement of the actuation devices.

Further aspects of the invention are described herein and presented in the Claims.

### BRIEF DESCRIPTION OF THE DRAWINGS

The exemplary embodiments will hereinafter be described in conjunction with the following drawing figures, wherein like numerals denote like elements, and wherein:

FIG. 1 is a cross-sectional perspective view of a wind turbine blade according to one known prior art construction;

FIG. 2 provides a more detailed view of a core used in the wind turbine blade of the prior art construction of FIG. 1;

FIG. 3A shows a scored core according to the prior art construction of FIGS. 1 and 2;

FIG. 3B shows a score free core, in accordance with various embodiments;

FIG. 4 illustrates a system and process for manufacturing cores for wind turbine blades, in accordance with various embodiments;

FIG. 5 illustrates a wind turbine blade in which a core of the shell has been divided into many curved core panels, in accordance with various embodiments;

FIG. 6 illustrates a first variant of a heating and moulding system for use in the system of FIG. 4, in accordance with various embodiments;

FIG. 7 illustrates a second variant of a heating and moulding system for use in the system of FIG. 4, in accordance with various embodiments;

FIG. 8 illustrates a third variant of a heating and moulding system for use in the system of FIG. 4, in accordance with various embodiments

FIG. 9 illustrates a trimming system for use in the system of FIG. 4, in accordance with various embodiments; and

FIG. 10 is a flowchart illustrating a process for manufacturing cores for wind turbine blades, in accordance with various embodiments.

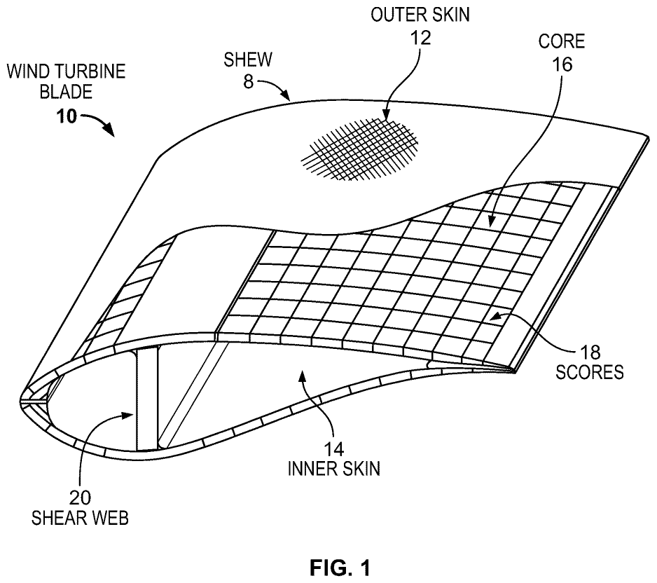

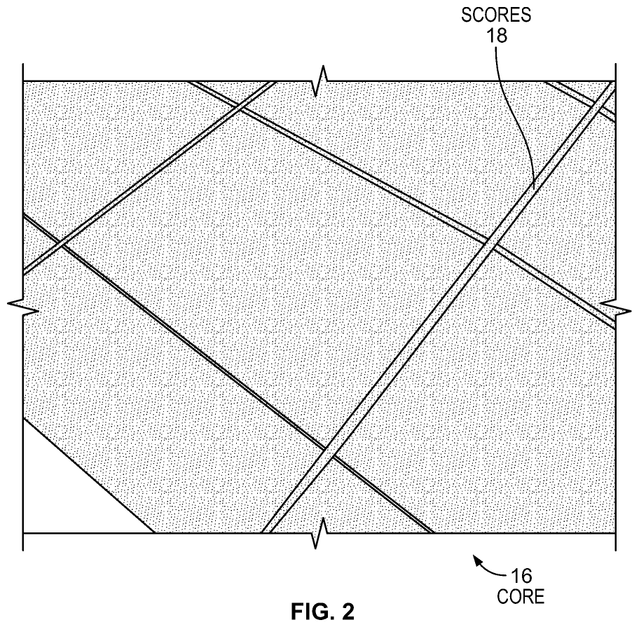

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

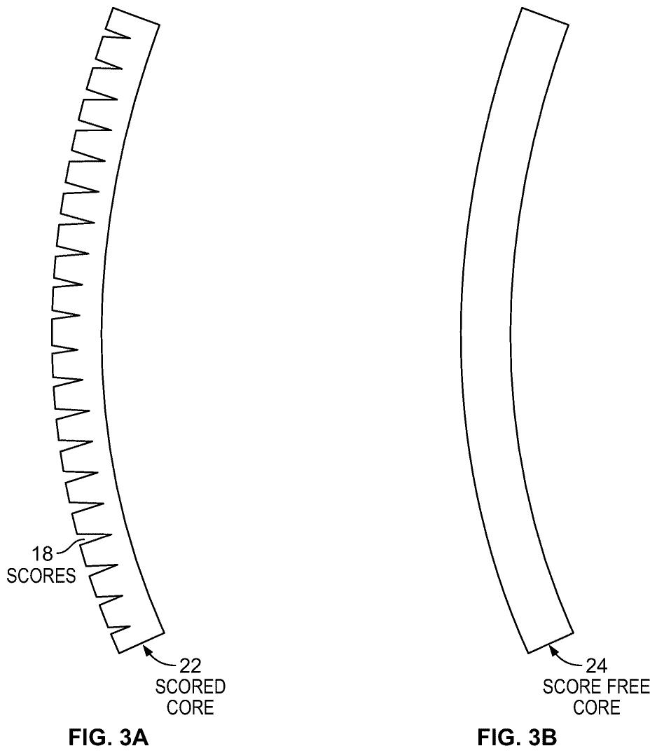

With reference to FIG. 3A, a scored core 22 according to a known construction is shown. The scored core 22 includes the scores 18 as discussed previously in order to allow the scored core 22 to be bent into a curved shape. These scores 18 provide resin flow paths by which the scored core 22 is impregnated with resin that aid in increasing the mechanical strength of the scored core 22 but to the detriment of increased weight. The scores provide fill sites for high density resin material such that when the scored core 22 is integrated into a sandwich structure of a shell of a wind turbine blade, the resulting sandwich core has varying material density. According to embodiments of the present disclosure, a score free core 24 is provided as exemplified in FIG. 3B that does not include a grid or any other pattern of scores and which is not infused with resin. Instead, the score free core 24 is moulded in its curved shape using a manufacturing process in which each core panel installed in making a wind turbine blade is individually moulded. The score free core 24 has a homogenous material density and does not have sites of step increase in material density as a result of resin impregnation. Such a score free core 24 is able to be moulded in closer conformity with a desired 3D curved shape according to a blade design, has a lower weight per square meter for a given thickness and may have greater mechanical strength since potential fatigue sites provided by the scoring and resin impregnation are avoided. A lower weight core for the sandwich structure of the shell of a wind turbine blade means that a higher performing wind turbine blade can be provided as a result of a longer blade (having the same weight) being employed and/or lower rotation resistance for the wind turbine.

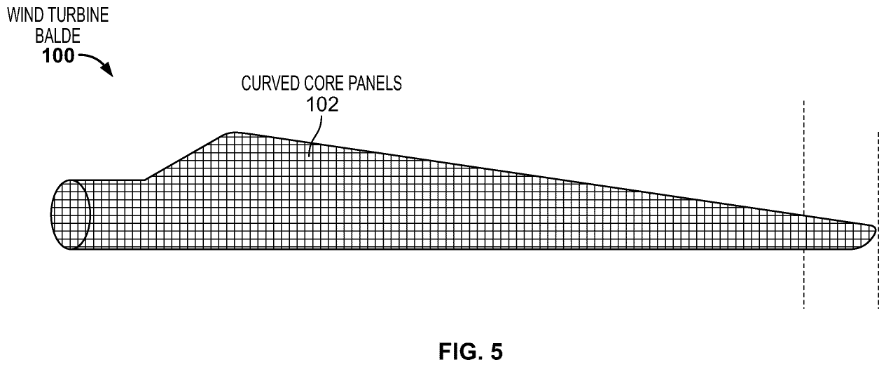

The score free core 24 can be of a variety of materials including polyethylene terephthalate (PET) foam, polyvinyl chloride (PVC) foam, Styrene acrylonitrile (SAN) foam and other thermoplastic materials that may be thermoformed into a desired curvature according to a wind turbine blade design. Typical densities of score free cores according to the present disclosure range from 40 kg/m³ to 400 kg/m³ . Each core panel (to be discussed later with respect to FIG. 5) may have a size of at least 1 m×1 m and have thicknesses ranging between 2 mm and 80 mm. A blade design is divided into many core panels (e.g. more than 100) and each core panel is individually thermoformed to a desired curvature according to the blade design. The core panels are arranged in a wind turbine blade mould at the designed location and moulded into a sandwich structure with inner and outer skins forming a shell of the wind turbine blade.

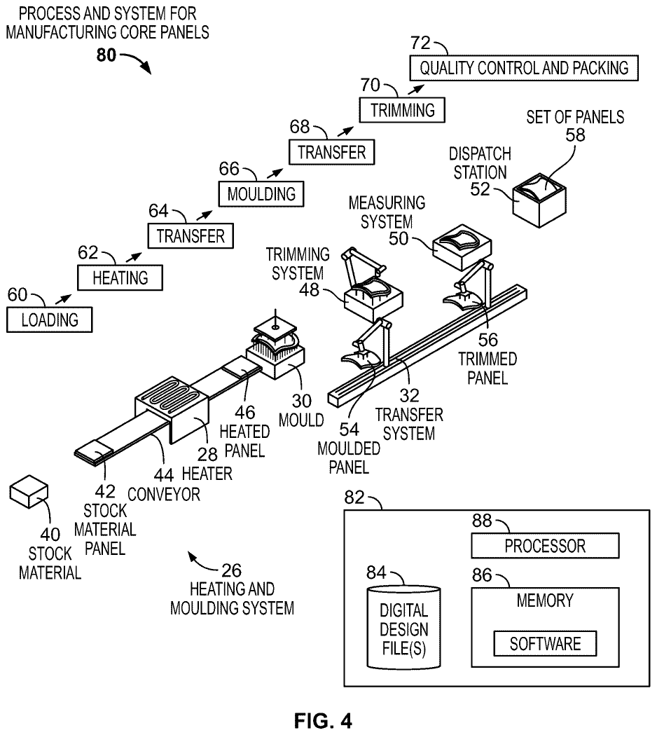

Referring to FIG. 4, an exemplary process and system for manufacturing core panels 80 is illustrated. As a precursor to the process illustrated in FIG. 4, a wind turbine blade design is divided into many curved core panels. With reference to FIG. 5, a three-dimensional (3D) digital design file for a wind turbine blade 100 is processed to produce 3D digital designs for curved core panels 102. That is, the 3D digital design file for the wind turbine blade 100 is processed to isolate a core of a sandwich structure forming the shell of the wind turbine blade 100 and the core is divided into many curved core panels 102. A significant majority (e.g. greater than 95%) of the curved core panels 102 will be of the substantially same area, i.e. are the same size pieces in area. Curved core panels 102 at the edges of the wind turbine blade 100 may require different sizes and there may be seam lines where curved core panels 102 also vary in size. The wind turbine blade 100 may have a longitudinal length from root to tip of 10 m or greater, 20 m or greater, 30 m or greater, 40 m or greater, 50 m or greater, 60 m or greater, 70 m or greater, 80 m or greater, 90 m or greater, 100 m or greater. The wind turbine blade 100 may be divided into 100, 200, 300, 400 or 500 or greater curved core panels 102. Each curved core panel may have an area of between 1 m² and 9 m², between 1 m² and 4 m² and between 1 m² and 2 m². The digital design file(s) for each piece is stored in a digital design file database 84 (see FIG. 4). The digital design file for the wind turbine blade 100 may also be stored in the digital design file database 84. As such, the digital design file database 84 includes a 3D digital design for each custom curved core panel 102 that is to be manufactured, which is used by the process and system for manufacturing core panels 80 of FIG. 4.

Referring again to FIG. 4, a control system 82 is included. The control system 82 provides processing capability to divide the 3D digital design file for the wind turbine blade 100 into many curved core panels 102 and also to control the process and system for manufacturing core panels 80. The control system 82 includes at least one processor 88 and a memory 80 in the form of computer readable storage device or media. The processor 88 can be any custom made or commercially available processor, a central processing unit (CPU), a graphics processing unit (GPU), an auxiliary processor among several processors associated with the control system 82, a semiconductor based microprocessor (in the form of a microchip or chip set), a macroprocessor, any combination thereof, or generally any device for executing instructions. The computer readable storage device or media may include volatile and nonvolatile storage in read-only memory (ROM), random-access memory (RAM), and keep-alive memory (KAM), for example. KAM is a persistent or non-volatile memory that may be used to store various operating variables while the processor 88 is powered down. The computer-readable storage device or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the control system 82 in controlling the process and system for manufacturing core panels 80. The control system 82 may be cloud based, local or a combination of both.

The processor 88 executes software 80 to perform processes for manufacturing core panels as described herein. The software 80 embodies instructions that may include one or more separate programs, each of which comprises an ordered listing of executable instructions for implementing logical functions. The instructions, when executed by the processor 88 create the digital design files for the curved core panels 102 as discussed (optionally with the aid of user input and direction) and control the process and system for manufacturing core panels 80. Although only one control system 82 is shown in FIG. 4, any number of control systems that communicate over any suitable communication medium or a combination of communication mediums and that cooperate to perform the processes described herein may be included.

FIG. 4 illustrates a source of stock material 40 including many pieces of equal size (area and optionally also thickness) core material. The stock material may be PET, SAN, PVC foam or other suitable thermoplastic material for use as core material for a wind turbine blade. The process and system 80 of FIG. 4 includes a step of loading 60 a stock material panel 42 of the stock material 40 onto a conveyor 44 (or other transport system) to move the stock material panel 42 to a heating and moulding system 26 for performance of the steps of heating 62 and moulding 66.

The heating and moulding system 26 may take a number of forms. Generally, the mould is configurable by the control system 82 to take on the 3D shape of the digital design file 84 for the curved core panel 102 that is being manufactured. The stock material panel 42 is heated to a pliable forming temperature and pressed in the mould to take on the desired curved shape. The heating temperatures may heat the stock material panel 42 to a suitable temperature depending on the material. For example, PET foam is heated to around 150° C. and SAN is heated to around 100° C. Generally, the stock material panel should be heated to a temperature between 90° C. and 200° C. The heating and moulding system 26 may perform heating prior to or simultaneously with pressing. The configuring of the mould may be performed prior to or simultaneously with pressing. Pressing may be performed with the assistance of vacuum in a one-sided mould or using a stamping process in a two-sided mould. A one-sided mould may allow greater manufacturing speeds.

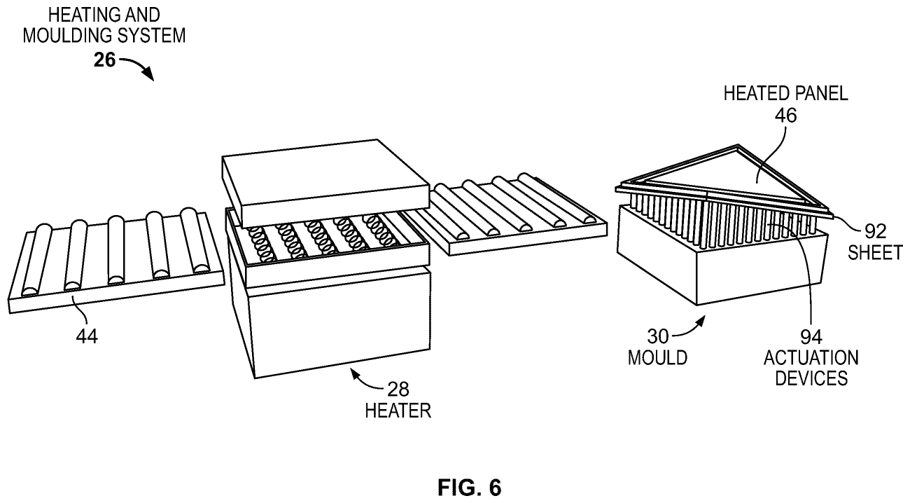

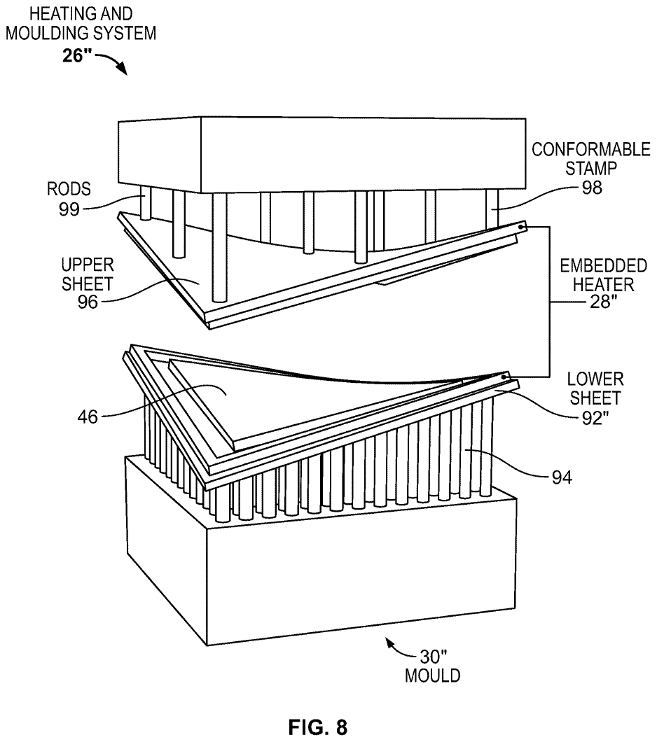

Exemplary embodiments of three different heating and moulding systems 26 are shown in FIGS. 6 to 8. In the first heating and moulding system 26 of FIG. 6, the heater 28 is positioned upstream of the mould 30 and the stock material panel 42 is heated while being moved through the heater 28 by the conveyor 44. According to the various heating and moulding systems 26 disclosed herein, the mould 30 includes an array of actuation devices 94, which may be in the form of linear actuators. The actuation devices 94 are actuated by the control system 82 to different lengths according to the digital design file for the curved panel being manufactured. A sheet 92 positioned above the actuation devices 94 conforms to the curved shape defined by the array of actuation devices 94 and the heated panel is pressed against the sheet 92 during the moulding process to take on the curved profile of the sheet 92 as shaped by the actuation devices 94. In the embodiment of FIG. 6, pressing is performed by applying a vacuum between an upper flexible sheet (not shown) and the sheet 92. Although vacuum moulding is considered efficient for one-sided moulding, other press moulding techniques may be implemented.

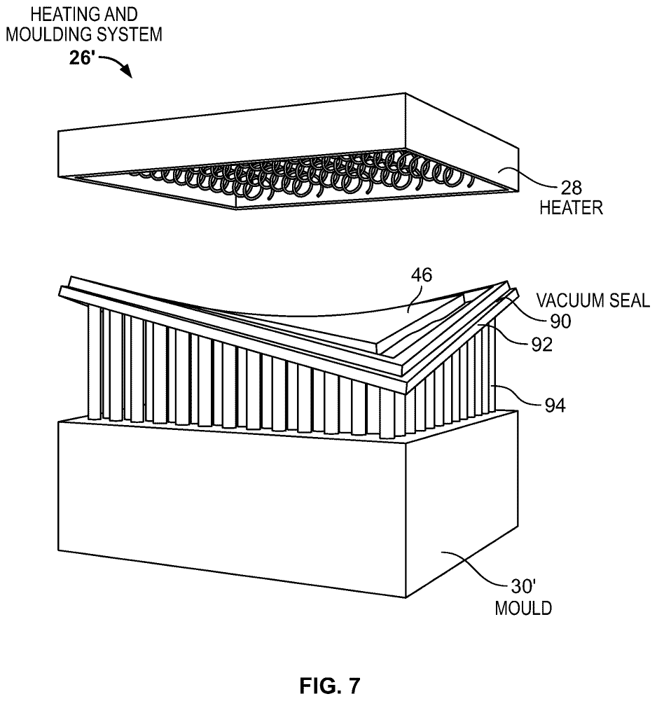

In the second heating and moulding system 26′ of FIG. 7, heating of the stock material 42 to produce a heated panel 46 is performed at the same time as moulding by the mould 30′. The mould 30′ forms a lower base supporting the heated panel and a heater 28′ is positioned above the mould 30′. The mould 30′ includes a vacuum seal 90 (and a vacuum providing system) so that an upper sheet (not shown) presses the heated panel 46 into the curved shape of the mould 30′.

In the third heating and moulding system 26″, a conformable stamp 98 presses against the heated panel 46 to take on the shape defined by the lower sheet 92″ and the array of actuation devices 94. The conformable stamp 98 may be provided by an array of extendable and retractable rods 99 that fix in length relative to an upper base when resistance is met as provided by the lower sheet 92″ and the actuation devices 94. In the third heating and moulding system 26″, an embedded heater 28″ is provided by resistance wires included in one of or each of the upper sheet 96 and the lower sheet 92″ such that heating and moulding is performed at the same location and so that heating and moulding may be performed simultaneously.

Referring back to FIG. 4, the heated panel 46 may be transferred to the mould 30 from the conveyor 44 by a transfer system 32 in a transfer step 64. Further, after the step of moulding 66, the moulded panel 54 may be transferred to a trimming system 48 in a transfer step 68. The transfer system 32 may include one or more robotic arms and suction end effectors for picking up and releasing the core panels.

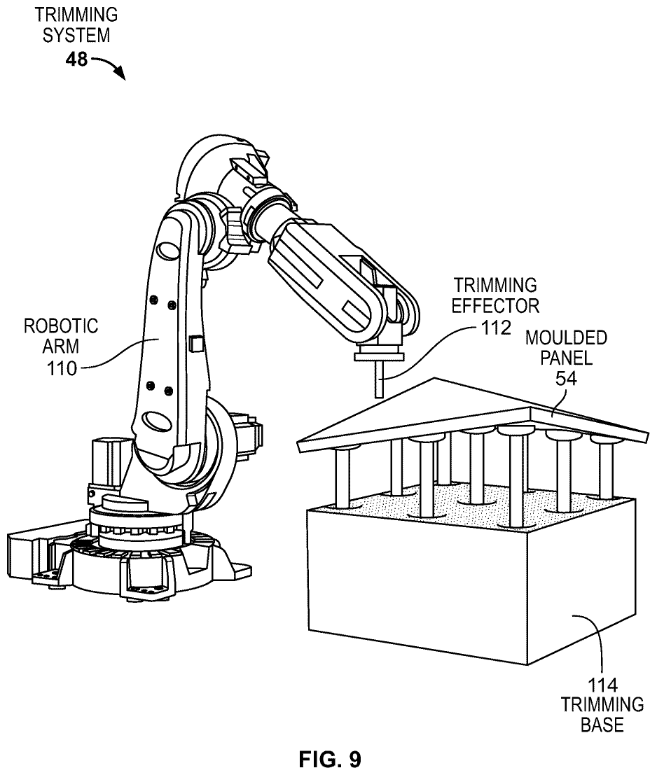

The moulded panel 54 is transferred from the mould 30 to a trimming system 48. FIG. 9 provides one exemplary embodiment of the trimming system 48, which includes a robotic arm 100 that spatially manipulates a trimming effector 112, which may be in the form of a cutting laser or other cutting tool. In other applicable trimming systems 48, a computer numerical control machine (CNC) supports a trimming tool (which be not be laser but may instead be a material machining tool such as drills, lathes, mills, grinders, etc). Any other trimming tool support and automated maneuvering machine may also be provided. A moulded panel 54 is supported on a trimming base 114 with height adjustable rods that are controlled by the control system 82 to take on the profile of the curvature of the moulded panel 54 according to the digital design file for the panel being manufactured. The trimming base 114 may take the form of a support table that supports the moulded panel with the height adjustable rods or other actuation devices being reconfigured for each moulded panel 54 depending on the respective digital design file. In this way, the support surface provided by the trimming base 114 for the moulded panel 54 exactly matches the two-dimensional curvature of the moulded panel 54 to provide a predictable support position and stability during the trimming process. A support fabric or sheet may be positioned between the actuation devices for the trimming base 114 and the moulded panel that follows the curvature defined by the actuation devices. The trimming effector 112 removes material from an outer periphery of the moulded panel 54 to match the dimensions instructed by the digital design file and to remove any unwanted moulding artefacts as part of a step of trimming 70 (see FIG. 4).

Referring again to FIG. 4, the trimmed panel 56 is transferred to a measuring system 50 by the transfer system 32 to perform precision measuring of the curvature and dimensions of the trimmed panel 56 as part of a step of quality control and packing 72. The measuring system 50 may use laser measuring technology, photogrammetry or other precision measuring system to measure the dimensions and curvature at a distribution of points (or continuously) on the trimmed panel 56. The control system 82 compares the measurements to the digital design file to ensure that the trimmed panel 56 is according to the desired specification within predetermined tolerances. The step of quality control packing includes arranging the final panel into a set of panels 58 at a dispatch station 52 for delivery to a manufacturing center for a wind turbine blade.

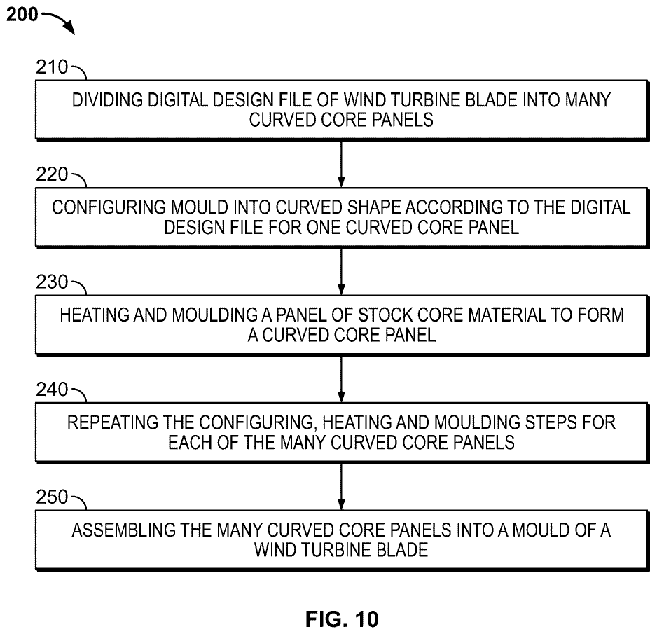

Referring now to FIG. 10, and with continued reference to FIG. 4, a flowchart illustrates a method 200 for manufacturing a wind turbine blade that can be performed by the system aspects of FIG. 4 in accordance with the present disclosure.

The method 200 includes step 210 of dividing the digital design file for the wind turbine blade 100 into many (or a population) of the curved core panels 102 as illustrated in FIG. 5. The digital design files for each of the curved core panels 102 is loaded into the digital design file database 84 for use by the control system 82 for use in manufacturing the curved core panels.

In step 220, the mould 30 is configured into a two dimensionally curved shape according to one of the digital design files for one of the curved core panels. The mould is so configured by changing a length of the actuation devices 94 relative to a base of the mould 30. A sheet 92 supported by the actuation devices 94 takes the curved profile defined by the actuation devices and the core panel is pressed into that form against the sheet 92. In step 230, a stock material panel is heated and moulded to form a curved core panel. As discussed previously, the heating and moulding can be performed in a number of ways. The moulding may be one-sided moulding using a vacuum moulding process or two-sided using an opposing conformable stamp. Heating may be performed before or during the moulding. The heating may be performed upstream of the mould 30 or at the same location using an embedded heater at the mould. The moulding may be performed between opposed sheets with at least one of the opposed sheets including a heater in the form of heating elements embedded therein.

The steps 220 and 230 are repeated in step 240 for each of the curved core panels making up the core of the sandwich structure of the shell of the wind turbine blade included in the database of digital design files 84. In this way, a set of panels 58 is provided that can be assembled into a wind turbine blade.

In step 250, the set of panels 58 produced by the process and system for manufacturing core panels 80 are assembled into a mould of a wind turbine blade. The mould may be off-site such that the set of panels 58 are delivered to the wind turbine blade manufacturing site. The core panels are arranged positionally according to the digital design file. The positional arrangement may be defined by detailed instructions (digital or otherwise) that get sent with the set of panels for use by the wind turbine blade manufacturer. An exemplary process is to first apply a first lay-up of glass fiber to the wind turbine blade mould using adhesive to form an outer skin of a shell of the wind turbine blade, to overlay the first lay-up with a curved core panel manufactured and positioned correctly as described herein and then to apply a second lay-up of glass fiber to provide the inner skin of the shell of the wind turbine blade. Epoxy resin is then infused, using vacuum bags, into the sandwich structure to integrate the inner and outer glass fiber layers with the curved core panel. The wind turbine blade shell may be made in two half-shells that are assembled together to form the entire shell of the wind turbine blade.

The present disclosure provides an automatic production line that tackles the central industry problem of mass production of unique elements in a way that does not require resin filled score lines. The automatic production line enables production of core panels for wind projects. The present process allows a core panel to be produced in 5 minutes or less on an automated production line, therby significantly improving efficiency of manufacturing of wind turbine blades, whilst reducing weight and enhancing strength.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

1. A method of forming curved panels for a core of a wind turbine blade, the method comprising:
providing a mould, the mould a sheet and a plurality of actuation devices;
controlling, via at least one processor, an arrangement of the plurality of actuation devices to curve the sheet based on a digital design file including a representation of a curved shape of a first curved panel to be moulded;
moulding heated stock material by pressing the heated stock material onto the sheet to form the first curved panel;
controlling, via the at least one processor, a rearrangement of the plurality of actuation devices to curve the sheet based on the digital design file including a representation of a curved shape of a second curved panel to be moulded; and
moulding heating stock material by pressing the heated stock material onto the sheet to form the second panel,
wherein the digital design file defines the core of at least part of the wind turbine blade that has been divided into curved panels, and
wherein the first and second panels may be assembled together to form the core of the at least part of the wind turbine blade.

2. The method of claim 1, wherein the mould includes a lower base associated with the sheet and an upper base associated with an upper sheet such that the sheet and the upper sheet form opposed sheets between which the heated stock material is moulded, wherein at least one of the lower base and the upper base has the actuation devices supported thereon.

3. The method of claim 1, wherein the actuation devices are linear actuators, wherein the actuation devices are adjustable, under control of the at least one processor, to adjust a length of the linear actuators to manipulate a shape of the sheet.

4. The method of claim 1, wherein the moulding is vacuum moulding.

5. The method of claim 1, comprising applying pressure on heated stock material against the sheet to force the heated stock material into conformity with a curved profile of the sheet, wherein the curved profile of the sheet is defined by an arrangement of the plurality of actuation devices as part of the moulding of the heated stock material.

6. The method of claim 5, wherein pressure is applied by vacuum or by a conformable stamp that takes the shape of the curved profile of the sheet.

7. The method of claim 1, wherein the sheet, an opposed upper sheet or both includes a heating element embedded therein to heat the stock material and to soften the stock material during moulding.

8. The method of claim 1, wherein the stock material is heated prior to transfer to the mould to soften the stock material.

9. The method of claim 1, wherein the at least part of the wind turbine blade is a shell thereof.

10. The method of claim 1, wherein the digital design file defines a shell of a wind turbine blade and the method includes digitally dividing the shell into curved panels making up the shell and repeating, for each of the curved panels, steps of controlling, via the at least one processor, a rearrangement of the plurality of actuation devices and moulding heated stock material.

11. The method of claim 1, comprising providing a trimming system that is controlled, by the at least one processor, to trim the first and second curved panels to a desired size according to the digital design file, wherein the trimming system includes a conformable support table for supporting the first and second curved panels that is actuatable and reconfigurable to provide a support service with a curvature that matches the curvature of the first and second curved panels according to their respective digital design files.

12. Curved panels for a core of a sandwich structure of a shell of a wind turbine blade made according to the method of claim 1.

13. A wind turbine blade comprising a core of a sandwich structure of a shell of the wind turbine blade made up of curved panels made according to the method of any claim 1.

14. A curved panel providing a core of a sandwich structure of a shell of a wind turbine blade, the curved panel made of a material that is set into a curved profile under heat and applied pressure and maintains the curved profile when cooled, wherein the curved panel has a homogenous density and is free of scoring.

15. A wind turbine blade comprising a shell having a sandwich structure, wherein a core of the sandwich structure is made up of differently curved panels assembled together, wherein each of the curved panels is according to the curved panel of claim 14.
